(19) United States
(12) Patent Application Publication
(10) Pub. No.: US 2006/0244253 A1
(43) Pub. Date: Nov. 2, 2006

(54) Texture coding label

(75) Inventor: Kaiyan Wei, Shenzhen (CN)

Correspondence Address: Raymond Y Chan, Suite 128, 108 North Ynez Avenue, Monterey Park, CA, 91754, US

(73) Assignee: Sinosun Technology (Shen Zhen Ltd.), Shenzhen (CN)

(21) Appl. No.: 10/526,144

(22) PCT Filed: Mar. 25, 2004
(86) PCT No.: PCT/CN04/00252

§ 371 Date: Nov. 22, 2005

(30) Foreign Application Priority Data
Sep. 22, 2003 (CN) 03274663.6

(51) Int. Cl. B42D 15/00

(52) U.S. Cl. 283/81

(57) ABSTRACT

The present invention discloses a texture coding label for certificating authentification of a genuine commodity, wherein the texture coding label comprises a fabric texture portion having a plurality of fiber threads randomly distributed therein to form a fiber image, and a two-dimensional bar code portion for recording a two-dimensional bar code generated by calculating the fiber image and a serial number of the commodity through a first predetermined algorithm. Since the texture coding label combines the texture coding technology, two-dimensional bar code technology and digital encryption technology, a uniqueness could be ensure for the commodity so as to enhance the anti-counterfeiting function.

### BACKGROUND OF THE PRESENT INVENTION

1. Field of Invention

The present invention relates to a forgery proof label, and more particularly to a texture coding forgery proof label for certificating authenticity of a genuine product.

2. Description of Related Arts

The piracy and counterfeiting of copyrighted and trademarked goods is a global phenomenon. It is estimated that merchandises manufactured without authorization from the rights holder have enormously impacted the business and commercial activities.

Nowadays, the globalization process, especially the rapid development of the international trade, have been fueling the counterfeiting activities thanks to an easier and more convenient distribution and transportation system around the world. In other words, forgery of commercial products is now at epidemic levels in many countries throughout the world. It is reported that the trading volume of counterfeited merchandises had increased at least 15% worldwide in last decade.

The actual lost sale attributed to counterfeiting is one only aspect of this problem. A serious result is the damage to the good name and reputation of the brand owner when inferior counterfeited merchandise is sold as genuine. Many successful corporations spend millions of dollars in advertising and other marketing efforts to create brand names and generate good will. However, those brand names have been wrongfully exploited for years by unscrupulous manufacturers and resellers of counterfeit products.

Unfortunately, these kind of illegal counterfeiting activities are inevitable, and seemingly, will last for a while to an unimaginable end. This is due to the fact that by pirating and forging the right goods, lucrative and tremendous profits could be achieved easily.

To combat the undesirable marketing effects impacted by the surge of counterfeits, a lot of companies and institutions have developed a variety of anti-forgery or anti-counterfeiting techniques for providing a high degree of security against illegal usage, such as anti-forgery paper, anti-forgery ink, anti-forgery printing technology, laser holographic anti-forgery technology, seal anti-forgery technology, and the like.

Generally, the above mentioned anti-forgery techniques are unexceptionally focused on the materials being used for anti-counterfeiting security purpose. Today, with the latest development of forgery technique, the traditional material anti-forgery technologies are no longer effective for deterring the counterfeit activities.

The best forgeries of product and security labels are conducted by hand by skilled artwork specialists equipped with the advanced computer software. For most consumers, this kind of forgery work is often impossible to authenticate without careful study by experienced personnel or by the application of specialized detection equipment.

It is noted that a desirable anti-forgery technique should not only deter the counterfeiting goods, but also provide a unique identification or a conspicuous mark to the authorized products. In other words, the anti-forgery techniques could be embodied as identifying marks for those right goods. What is more, the anti-forgery product should provide the right product a unique mark so that people could tell the difference with similar products.

Modern anti-forgery technologies have been developed into two classifications, i.e. anti-forgery technology focusing on the product uniqueness, and anti-forgery technology featuring on the commonness and identity of the products. As their name applied, the first anti-forgery technology provides each object to be protected a unique mark, or an individual character, while the second technology provides all merchandise an identity mark, or a general character.

Generally, the conventional anti-forgery techniques employ the common-character anti-forgery protection method. However, the common-character anti-forgery technology seems like a double-edged sword. It is convenient to be applied for protecting a great quantity of goods from being counterfeited and for being used for a mass-production process. On the other hand, if the anti-forgery techniques used was deciphered or broken through, all goods using the same common character protection method are vulnerable to be forged.

This is the reason why a lot of branded products have to change the anti-forgery measure from time to time. In short, the common-character anti-forgery technology is far from satisfaction, and the frequently changed anti-forgery measures are apt to cause confusion and authentification difficulty to customers.

In contrast, the uniqueness concerned anti-forgery technology provides the goods individual character. As a result, the counterfeiting activities will face a challenging job to forge all the products.

Recently, with the development and exploration of the information technology, anti-counterfeiting technology has been revolutionized into a new realm. Individuality concerned anti-counterfeiting technology associated with the late information innovations has been facilitated the development of the anti-counterfeiting industry. Principally, the advanced anti-counterfeiting technology are based on the computer software and digital printing techniques, such as machinery readable anti-counterfeiting coding techniques including anti-counterfeiting code, anti-counterfeiting IC card, anti-counterfeiting two-dimensional bar code (matrix code), encryption algorithm techniques, and personal biological property identification techniques.

Conclusively, most anti-forgery products currently available in the market employ the common-character anti-forgery technology. However, under some special circumstances, such as the protection for financial checks, ID card, and highly differentiated, luxury commodities, traditional anti-counterfeiting methods are by no means the best choices. Especially for financial commodities, the anti-counterfeiting requirements are extremely strict. This is due to the fact once such kind of commodities were forged, the losses and subsequent effects are always devastating. It is not reliable for customer to judge the authenticity of such kind of commodities by naked eyes and touching sensitivity.

Therefore, there exists a need to develop a kind of anti-forgery product being facilitated with some advanced anti-counterfeiting techniques.

### SUMMARY OF THE PRESENT INVENTION

A primary object of the present invention is to provide a texture coding forgery proof label and a method of automatically identifying the authentication of genuine products by verifying the label's unique features of the embedded fibers, as well as its corresponding digital signature embodied in the label with a special device, wherein each of the forgery proof label is uniquely featured with the embedded fibers.

Another object of the present invention is to provide a forgery proof label and a method thereof, wherein the texture coding technique is applied for facilitating the anti-counterfeiting function. That is to say, customer will no longer judge the authentification by visually identifying the fiber embedded in the paper, but, by detecting the labels with a special device, identify the features of the embedded fibers, such as their random distribution, curve, and density, so that the counterfeiting activities are significantly deterred.

Another object of the present invention is to provide a texture coding forgery proof label, which comprises a 2-demetion bar code, is associated with advanced information technology, for example, CA, PKI, digital encryption, and so on, so that the authentification process could be guaranteed.

Another object of the present invention is to provide a texture coding forgery proof label, which is associated with conventional watermark anti-forgery technology.

Another object of the present invention is to provide a texture coding forgery proof label, which is detected by a special device for ensuring the authentification so as to eliminate the human errors.

Another object of the present invention is to provide a method for certificating the authentification of a genuine commodity by utilizing a texture coding label.

Accordingly, in order to accomplish the above mentioned objects, the present invention provides a method for certificating authentification of a genuine product by utilizing a texture coding forgery proof label, comprising the steps of extracting a fiber image from the texture coding label by a camera processor; calculating the fiber image to generate an image property by computing means; composing a plaintext to be encrypted by a digital certification process; encrypting the image property, the plaintext, and other information by an encrypted algorithm, two-dimensionally encoding the encrypted image property, plainstext, PKI (Public Key Infrastructure) Certificate, digital signature and other information, by a first predetermined algorithm to generate a two-dimensional bar code, and printing the two-dimensional bar code in a reserved portion of the texture coding label.

Through such steps of identification, data generating, and ascertaining with special equipments, a unique identification label is thus generated.

Furthermore, in order to accomplish the above mentioned objects, the present invention provides a texture coding label for certificating authenticity of a commodity, having:

a fabric texture portion having a plurality of fiber threads randomly distributed therein to form a fiber image;

a two-dimensional bar code portion for recording a two-dimensional bar code generated by calculating the fiber image and a serial number of the commodity through a first predetermined algorithm; and

a displaying portion for showing a plurality of visible data generated by calculating information of the two-dimensional bar code portion through a second predetermined algorithm;

wherein by applying a special device, a user is capable of taking the fiber image and calculating the two-dimensional bar code by the first predetermined algorithm, and by comparing two-dimensional bar code with the visible data, the use is capable of telling the authentification of the commodity, since technologies such as texturing coding forgery proof technology, two-dimensional bar code technology, and digital encryption technology have been used, a uniqueness of the commodity is ensured so as to enhance the anti-counterfeiting function.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a texture coding label for certificating authenticity of a genuine commodity according to the preferred embodiment of the present invention.

FIG. 2 shows the above texture coding label being radiated by a visible light.

### DETAILED DESCRIPTION OF THE PREFERRED EMBODIMENT

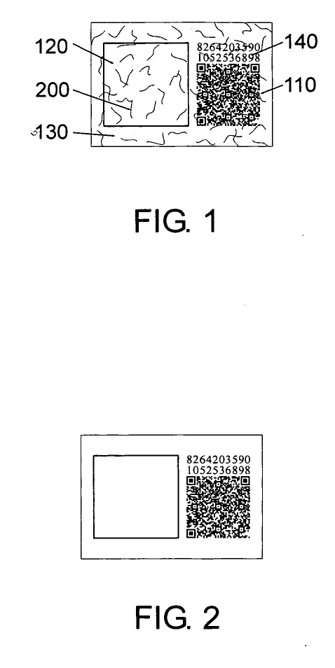

Referring to FIGS. 1 and 2 of the drawings, a texture coding label for certificating authenticity of a commodity according to the preferred embodiment of the present invention is illustrated. The texture coding label comprises a fabric texture portion 120 and a two-dimensional bar code portion 110, wherein the fabric texture portion 120 has a plurality of fiber threads 200 randomly distributed therein to form a fiber image, and the wherein a two-dimensional bar code portion 110 is adapted for recording a two-dimensional bar code generated by calculating the fiber image and a serial number of the commodity through a first predetermined algorithm.

Further, the texture coding label has a displaying portion 140 for showing a plurality of visible data generated by calculating information of the two-dimensional bar code portion through a second predetermined algorithm and a watermark 130.

By applying a special device, a user is capable of taking the fiber image and calculating the two-dimensional bar code by the first predetermined algorithm, and by comparing two-dimensional bar code with the visible data, the use is capable of telling the authentification of the commodity, since technologies such as texturing coding forgery proof technology, two-dimensional bar code technology, and digital encryption technology have been used, a uniqueness of the commodity is ensured so as to enhance the anti-counterfeiting function.

According to the preferred embodiment, the present invention further provides a method for certificating authentification of a genuine product by utilizing a texture coding forgery proof label, comprising the steps of:

(a) extracting a fiber image from the texture coding label by a camera processor;

(b) calculating the fiber image to generate an image property by computing means;

(c) composing a plaintext to be encrypted by a digital certification process;

(d) encrypting the image property, the plaintext, and other information by an encrypted algorithm;

(e) two-dimensionally encoding the encrypted image property, plainstext, PKI (Public Key Infrastructure) Certificate, digital signature and other information, by a first predetermined algorithm to generate a two-dimensional bar code; and

(f) printing the two-dimensional bar code in a reserved portion of the texture coding label;

According to the present invention, the fiber thread 200 is transparent when exposure to natural light (“transparent fiber thread”), and is adapted for emitting a visible light under a radiation of lights of certain wavelength.

Here, the light of certain wavelength is selected from a group consisting of ultraviolet light, infrared light, and so on.

Further, the fiber thread is a colored fiber thread, and the light emitted by the fiber thread is red, blue or orange.

Furthermore, the texture coding label has a smooth surface and an opposed mat surface wherein the mat surface is embodied as an adhesive tape, so that the texture coding label is capable of being adhering to the genuine commodity easily.

It is noted that the fabric texture portion and the two-dimensional bar code portion are overlapped that the two-dimensional bar code portion is overlappedly formed on the fabric texture portion.

According to the preferred embodiment of the present invention, the individuality concerned anti-counterfeiting technology is employed, which comprise image identification technology, SSL encryption technology, and bar code technology. Compared with common character anti-forgery technology, a special identifying device is applied in the individuality based anti-forgery technology.

The present invention generally employs the texture property of fiber and two-dimensional bar code technology, and ascertains whether a product or certain checks are authentic through such techniques in image taking, processing and printing. Of course, with the development of technology, the fiber thread 200 in the present invention may be the fiber texture of the label itself, as long as this texture varies randomly.

The colored or transparent fiber thread 200 and watermark 130 adopted in the present invention are traditional techniques whereby customers can ascertain visually whether colored fiber thread 200 or watermark exists inside the paper, or ascertain the fluorescent fiber under radiation of light of certain wavelength. Besides these two traditional techniques of fiber thread 200 and watermark 130, the texture coding label of the present invention further applies the two-dimensional bar code technology after image taking process and texture property calculating process. The focus of this technology is the texture property of the fiber thread 200 inside the paper, rather than simply ascertaining whether fiber thread 200 exists inside. Here, the texture property includes the distribution, density, curve extent and so on.

It is noted that the raw materials for preparing the texture coding label of the present invention should meet the following requirements:

(1) Paper: first of all, commonly, the fiber thread 200, such as wool, is more or less impacted by the paper pulp (paper fiber) in the paper-making process. According to the present, to ensure a desirable quality of imaging of the texture, paper pulp (paper fiber) is required not impact the reflex process of the transparent fiber thread 200. Secondly, colored fiber thread 200 should not be embedded too much in the fabric texture portion. In that way, it would be difficult for the identification means to detect the fiber thread 200. Finally, adhesive tape is provided to the mat surface of the fabric texture label. To achieve a firm attachment, the finish grade of the paper should be considered. It is worth to mention that the substrate of the texture coding label of the present invention is not limited to paper; other materials being suitable for detection and manufacturing are of options.

Preferably, the texture coding label of the present invention is made of long fiber materials, such as cotton and hemp, for an easy imaging process of the fiber thread 200, and the paper is strong and wearable so that the label is easy to be detached off from the commodity, and more importantly, the label has a smooth surface for facilitating the imaging and printing process, and a mat subsurface on the opposite side for embodying the adhesive tape function. It is noted that the paper for preparing the texture coding label shall not be too thick, and preferably, the label should weight about 50g. This is due to the fact that only one layer of fiber thread 200 is disposed between the surface and the mat subsurface of the texture coding label.

(2) Watermark 130: watermark 130 is one of the prior art being used in the present invention. Preferably, the watermark is clearly visible to the naked eyes, and is uneven when being touched.

In the paper making process of the present invention, watermark pattern block could be installed in the silk screen or pressed by cylinder press. The unevenness of the pattern enables the paper pulp to generate corresponding and different pulp density. As a result, the different paper pulp density will cause a huge variance of light penetration on a paper. So, the original pattern, i.e. watermark, will be displayed when the paper is exposure to lights. Within the art, watermarks could be classified into three categories: fixed watermark, semi-fixed watermark and unfixed watermark.

Fixed watermark is provided in a certain place of a paper, and is perfectly matched with visible patterns or other anti-forgery measures. For semi-fixed watermark, there are sets of watermark arranged in a consecutive manner, wherein the distance and position of each set of watermark are fixed. Generally, the semi-fixed watermark is called consecutive watermark, which is mostly applied in paper for special usage. Unfixed watermark is distributed on the full paper (full space watermark). It is noted that fixed watermark is difficult to print among above watermark features. And finally, there are raised design and recessed design of watermark preparing process.

According to the preferred embodiment of the present invention, to the cylinder press technique and raised design are applied on the plate making process for preparing the watermark and the fixed watermark is utilized. As a result, the counterfeiting for the watermark is rather challenging, and the uneven watermark is customer friendly.

(3) Fiber thread 200: according to the present invention, special equipments are utilized to detect the fiber thread 200 property (including colored thread and transparent thread), to take a fiber image with the image sensor and digitalize the taken fiber image. As shown in FIG. 1 and FIG. 2, a plurality of fiber thread 200 is disposed in the fabric texture portion 120. It is noted that the fiber thread 200 could be integrally made by adding an amount of fiber thread 200 to the paper making process, or by purposely disposing the fiber thread 200 into the fabric texture portion after the paper making process. It is therefore necessary to have a sign for circumscribing the fabric texture portion on the label.

According to the preferred embodiment, if colored fiber thread is used, the fiber thread is embedded within the paper as long as its visibility is guaranteed, so that the paper is a proper thickness; or if transparent fiber thread is used, the main concern is shifted to the image sensor and its camera, which are sensitive to the light. Due to transparent fiber absorbs light of certain wavelength and reflects as visible light, a wavelength suitable for the image sensor is required; secondly, a certain amount and density of the fiber thread 200 is required to enhance the intensity of anti-forgery function; and finally, to ensure the fiber's texture property, there are also certain requirements on the fiber's length and softness, so that the fiber thread 200 inside paper has a variety of shapes so as to deter the counterfeiting attempts.

Fiber thread 200 could be added proportionally to the paper pulp during paper making process. The fiber thread 200 used in the present invention is but not limited to colored thread and transparent thread. Generally, the pieces of fiber thread 200 may be long or short, thin or thick, the color be red, blue or orange, is randomly distributed, is arranged with a relative density, is embedded within the paper, is capable of being picked out by a needle, and is capable of being clearly distinguished under a microscope from those pressed or printed on the surface of the paper.

For the fiber thread 200 used in the present invention, there are certain requirements on the fiber length, diameter, color, amount in a certain area and the thickness of the paper, this is due to the fact that these properties could have substantial influence on the quality of the fiber image, and the amount of fiber thread 200 is also related with the ability to prevent forgery after encryption process.

Accordingly, the fiber thread 200 is required to be soft, able to curve in random direction and shape. But once the fiber thread 200 is shaped in the fabric texture portion 120, the texture in the fabric texture portion will be kept unchangeable thus representing a unique texture property.

(4) two-dimensional bar code: the texture coding label of the present invention applies two-dimensional bar code technology, so that a portion of the paper is reserved for printing the relevant information, such as CA certificate, image property, plaintext, other information, and digital signature etc. As illustrated in FIG. 1 and FIG. 2, the two-dimensional bar code is printed in the two-dimensional bar code portion 110. Considering the paper type and amount of information to be printed, the form of the two dimensional bar code should be suitable for the label of the present invention, and so does the type of printer. It is noted that the fabric texture portion 120 and the two-dimensional bar code portion 110 could be overlapped to save the material in production. In addition, the texture coding label and the object whereto it is adhered could be integrally designed to form an overall appearance, therefore, there are also certain requirements on the surface of that object to be protected.

(5) Adhesive tape: the texture coding label of the present invention is adapted to be adhered to products or important financial notes such as bill of exchange. Therefore, the base paper of the texture coding label should be embodied to be detached easily from the label when the label is originally used. Furthermore, the adhesives used on the backside of the label should have a “dry-fast” feature so that label would be hard to be reused after being taken off from an object. Finally, the adherence intensity should be firm so that once the label is adhered to a product or check, bill of exchange, etc., it would be rather difficult to detach the label from the check or the not without damaging the protected product.

According to the different requirement, the texture coding label could be embodied as a consecutive roll or a flat paper. There is a plurality of cutting line between adjoining texture coding labels.

FIG. 1 is a sample of a texture coding label of the present invention being exposure to ultra violet light and FIG. 2 shows the texture coding label under natural light, wherein the fabric texture portion 120 is a specified area for extracting a fiber property. It is noted that the fiber thread 200 reflects red light under UV radiation. In case of the colored fiber thread is applied, the fiber thread 200 is capable of reflecting an image which is distinguishingly differs from the background of the paper. Furthermore, the watermark 130 is visually identifiable, and the two-dimensional bar code is shown inside the two-dimensional bar code portion 110. Finally, visible numbers up to 20 digits could be printed in the displaying portion 140 wherein the visible number is generated from a second predetermined algorithm and is visually identifiable.

Conclusively, the present invention represents the following advantages in comparison with conventional anti-counterfeiting approaches:

(I) the texture property, the random distribution and the amount of the fiber are concerned in the present invention. However, the traditional methods just provide a function for customer visually identifying the fiber to judge whether fiber threads exist inside the paper. It is apparent the embodied characters like random distribution and texture property will significantly increase the counterfeiting difficulty thus deterring the forgers.

(II) In the present invention, an intensive encryption algorithm has been introduced, such as encryption and signature, CA Certificate, and PKI system are adopted in the label to ensure that information contained in the label is unchangeable and thus ensure the security of the identification system. First of all, the fiber image information is expressed in digitalized eigenvector and stored in the two-dimensional bar code, and the two-dimensional bar code also contains Certificate and digital signature on the eigenvector and plaintext. In such way, a strict mathematic relationship in cryptogram is established among the information of the fabric fiber portion, two-dimensional bar code portion and the visible message on the commodities or checks, so that any change to the above information will immediately lead to a failure in identification. Secondly, the present invention has adopted the PKI system, which assigns different private key to each of the anti-forgery device, so that information transferring through the identifying process is ensured to be integrated, confidential, and undeniable. Furthermore, CA Certificate ensures the safety of encrypt management and distribution of the private key.

(III) Since the cylinder pressed watermark is adopted, the texture coding label of the present invention will generate an uneven touching sensibility when being held in hand. In other words, the unevenness of the watermark area could be clearly perceived by customer and content of watermark could be visually identified.

(IV) The traditional anti-forgery technology requires that a user has a certain level of knowledge on anti-forgery products and anti-forgery technologies. However, even a customer being well aware of these technologies could not judge correctly in some occasions. The identification system of the present invention employs a special equipment to identify the texture property of the label thus enormously eliminating the personal mistakes.

(V) Each texture coding label has a unique texture property. Theoretically, when an independent image property is scanned by a 100 bit data array, the chance for two labels having an identical image property is less than 10^{-30.}

(VI) Traditional anti-forgery technologies are generally applied as visual identification, which is called the “first line of defense” in the art; while the texture coding label of the present invention employs special equipment for certificating the authenticity besides the traditional technology.

(VII) The texture coding label of the present invention could meet the above mentioned requirements on modern anti-forgery products, i.e. it not only provides the genuine products a unique property, but also makes the genuine products to be counterfeit proof.

(VIII) Since a set of advance digital techniques have been used for facilitating the identification process, such as image taking, encryption, and digitalization, a reliable authentification could be guaranteed.

(IX) The adhesive tape used in the present invention enable the texture coding label dry-fast and firmly attached on the genuine commodity.

In conclusion, the text coding label of the present invention is of high utility, particularly as forgery proof product for protecting high valued products. In the meanwhile, the text coding label is working associated with special equipment, so that an accurate identification and intensive protection could be ensured.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A texture coding label for certificating authenticity of a commodity, having at least a fabric texture portion and a two-dimensional bar code portion, wherein said fabric texture portion has a plurality of fiber threads randomly distributed therewithin to form a fiber image, wherein a two-dimensional bar code which is stored said two-dimensional bar code portion and is a combination of said fiber image and a serial number of said commodity through a first predetermined algorithm.

2. The texture coding label, as recited in claim 1, wherein said fiber threads are transparent under nature light and emit visible lights under a radiation of light at certain wavelength.

3. The texture coding label, as recited in claim 3, wherein said radiation of light at certain wavelength is selected from a group consisting of ultraviolet light and infrared light.

4. The texture coding label, as recited in claim 1, wherein said fiber threads are pieces of colored fiber threads.

5. The texture coding label, as in claim 2 or 4, wherein visible light from said fiber threads is selected from a group consisting of red, blue and orange.

6. The texture coding label, as in claim 2 or 4, further comprising an anti-forgery watermark.

7. The texture coding label, as recited in claim 6, further having a displaying portion including a plurality of visible data generated by two-dimensional bar code in said two-dimensional bar code portion through a second predetermined algorithm.

8. The texture coding label, as recited in claim 7, further having a smooth surface and an opposed mat surface, wherein said mat surface has an adhesive ability for adhering on a surface of said commodity so as to attach said texture coding label on said commodity.

9. The texture coding label, as recited in claim 1, further having an adhesive ability for adhering on a surface of said commodity so as to attach said texture coding label on said commodity.

10. The texture coding label, as recited in claim 1, wherein said two-dimensional bar code portion is overlapped on said fabric texture portion.
